(19) United States
(12) Patent Application Publication
(10) Pub. No.: US 2025/0022268 A1
(43) Pub. Date: Jan. 16, 2025

(54) TRAINING OF A NEURAL NETWORK FOR BETTER ROBUSTNESS AND GENERALIZATION

(71) Applicant: Robert Bosch GmbH, Stuttgart (DE)

(72) Inventors: Haiwen Huang, Tübingen (DE); Nikita Kister, Tübingen (DE); Dan Zhang, Leonberg (DE)

(21) Appl. No.: 18/753,036

(22) Filed: Jun. 25, 2024

(30) Foreign Application Priority Data
Jul. 10, 2023 (DE) 10 2023 206 522.3

(51) Int. Cl. G06V 10/82; G06V 10/774; G06V 10/80

(52) U.S. Cl. CPC G06V 10/82; G06V 10/774; G06V 10/811; G06V 2201/12

(57) ABSTRACT

A method for training a task neural network for a task to be performed on an input including images. The method includes: providing 2D training images labelled with ground truth; expanding the training images into 3D representations; processing, by the task neural network, the 2D training images into task outputs; processing, by an auxiliary neural network, the 3D representations into auxiliary outputs; rating, by a task loss function, a deviation of the task output for each training image from the ground truth with which it is labelled; rating, by an auxiliary loss function, a plausibility of an outcome of the task neural network produced from at least one training image with the an outcome of the auxiliary neural network produced from the corresponding 3D representation; aggregating values of the task loss function and the auxiliary loss function; and optimizing parameters that characterize the behavior of the task neural network.

### CROSS REFERENCE

The present application claims the benefit under 35 U.S.C. § 119 of German Patent Application No. DE 10 2023 206 522.3 filed on Jul. 10, 2023, which is expressly incorporated herein by reference in its entirety.

### FIELD

The present invention relates to the training of neural networks that may, in particular, be used for evaluating images in the process of steering vehicles and/or robots.

### BACKGROUND INFORMATION

The at least partially autonomous steering of vehicles and/or robots in road traffic, and also on industrial premises, requires a constant surveillance of the environment of the vehicle and/or robot. For the purpose of such surveillance, it is customary to acquire images of the environment and analyze these images with trained neural networks with respect to a given task. Examples of such tasks are the classification of the images as a whole, and/or of objects shown in the images.

This process is supposed to mimic driving classes for human drivers in that the training based on a finite number of training situations will empower the neural network to perform the task just as well in a lot of unseen situations. However, this power to generalize is mostly limited to a domain and/or distribution to which the training images used for the training of the neural network belong.

### SUMMARY

The present invention provides a method for training a task neural network for a given task. This given task is to be performed on an input comprising at least images. That is, the neural network may, in addition to images, also accept other types of input, such as radar or lidar point clouds. In particular, the images may assign, to each pixel in a regular grid in the image plane, one or more intensity values. For example, the images may be RGB images that provide, for each pixel, intensity values of red, green and blue primary colors.

According to an example embodiment of the present invention, in the course of the method, 2D training images that are labelled with ground truth with respect to the given task are provided. If the neural network accepts further inputs in addition to images, the ground truth may apply to the complete record of training data that comprises both the training image and the further inputs.

At least a subset of the training images are expanded into 3D representations of the content of the respective training image. That is, while the training image may be viewed as a function that assigns pixel values to a pair of coordinates within a plane (such as Cartesian coordinates x and y), the 3D representation may be viewed as a function that assigns values to three coordinates within the image plane (such as Cartesian coordinates x, y and z).

The to-be-trained task neural network processes the 2D training images into task outputs. If the task neural network additionally accepts further inputs, the complete record of training data comprising both the training image and the further inputs is processed into the task outputs.

According to an example embodiment of the present invention, an already trained auxiliary network processes the 3D representations into auxiliary outputs. The auxiliary network has been trained for an auxiliary task. This auxiliary task may be the same as the given task, or at least similar to the given task. But this is not required. The output of the auxiliary network may be a useful feedback for the training even if the auxiliary task is, on the face of it, not related to the given task. The reason is that many neural networks, in particular convolutional networks, first extract basic features from the input image, then combine them into more complex features and finally solve the given task based on these more complex features. The same extracted features may be used for many different tasks.

According to an example embodiment of the present invention, a task loss function rates the deviation of the task output for each training image (or training image plus further inputs) from the ground truth with which this training image (or combination of training image and further inputs) is labelled.

Furthermore, according to an example embodiment of the present invention, an auxiliary loss function rates a plausibility of an outcome of the task neural network produced from at least one training image with the an outcome of the auxiliary neural network produced from the corresponding 3D representation. In particular, such plausibility may measure
how probable the outcome of the task neural network is given the outcome of the auxiliary neural network, and/or
how probable the outcome of the auxiliary neural network is given the outcome of the task neural network.

In particular, the outcome of the auxiliary neural network may be of the same type as the outcome of the task neural network, or it may be at least of a similar type. But this is not required. Rather, even outcomes of very different types may be plausible with respect to each other or not, depending on whether the training state of the to-be-trained task neural network is good or not.

According to an example embodiment of the present invention, the value of the task loss function and the value of the auxiliary loss function are aggregated into a total loss. Parameters that characterize the behavior of the task neural network are optimized towards the goal of improving the total loss.

The inventors have found that a training that is performed at least partially on 3D knowledge causes the task neural network to generalize better to input images from other domains and/or distributions than that to which the training images belong. At the same time, the task neural network becomes more robust against noise in the input data.

In particular, the task neural network can cope better with domain shifts between the domain of the training images and the domain of later input images during normal operation (inference) of the task neural network. For example, the training of a task neural network for analyzing driving scenes may have been performed with images acquired during daytime, but the vehicle is also expected to analyze driving scenes during nighttime. The use of the auxiliary neural network during training encourages the task neural network to learn generalizable features that are relatively invariant across different domains. For example, in the use case of detection and/or classification of objects in images, shapes of objects are well suited to discriminate between objects of different types irrespective of lighting conditions.

The use of 3D knowledge is particularly suitable for this because the delta of the 3D knowledge over 2D knowledge is primarily geometric information that is invariant to variations in lighting, colors and other imaging properties.

From this point of view, it would be better to solve the given task in 3D instead of 2D altogether. But solving the given task in 3D would consume more resources at multiple stages in the process. First, 3D input images, rather than 2D input images, would have to be provided. This would require either means to directly acquire the input image in 3D, or a computational expanding of each and every 2D input image to a 3D image. Second, the 3D image has a much larger data volume than a 2D image. This means that more communication bandwidth is required to convey the 3D image to the task neural network for processing, and more processing power and memory are required for solving the given task in a given amount of time. But in many safety-critical real-time applications, such as the steering of a vehicle and/or robot, memory and processing power are at a premium. Mobile applications in vehicles and/or robots place limits on the size, the power consumption, and/or the heat generation, of the used hardware. Also, hardware with a high safety integrity level, SIL, for safety-critical applications is very expensive.

Therefore, it is advantageous to only perform the training in 3D in order to reap the benefits of the 3D processing, and then solve the given task in 2D in order to minimize the resource consumption. That is, the effort of the 3D processing is expended only once during training, but inference that will be performed time and time again will be kept as efficient as possible.

In particular, because the use of the 3D knowledge is directly integrated into the main training with a further loss term, rather than being limited to a pre-training step, there can be no “catastrophic forgetting” of the 3D knowledge during optimization towards the 2D task.

In a particularly advantageous embodiment of the present invention, the auxiliary task is chosen to correspond to the given task. Herein, “correspond” is understood to mean that the two tasks are at least of the same type, such as classification or segmentation. In this manner, the value of the task loss function and the value of the auxiliary loss function can both be expected to have similar dependencies on the training state of the task neural network. The additional consideration of the auxiliary loss function is then more of a regularization of the original given task than it is of a completely different training objective.

In a further particularly advantageous embodiment of the present invention, the expanding of at least one training image into a 3D representation comprises computing a depth map that contains, for each pixel of the 2D training image, a distance from the camera with which the training image was recorded. For the generation of depth maps, many tried-and-tested methods are available.

In particular, the depth map may then be further processed into a 3D image that assigns pixel values of the 2D training image to locations outside of the plane of this 2D training image. For example, such a 3D image may be in the form of a point cloud that assigns values to some, but not all, points in a volume. For this, standard libraries, such as Open3D, are available.

In one example embodiment of the present invention, before the processing into a 3D image, the depth map is cropped to comprise only a set of desired objects or other semantic sub-units of the training image. The resulting point cloud may then, for example, be provided to an auxiliary neural network that is trained to classify, or otherwise analyze, individual object instances.

In a further advantageous embodiment of the present invention, the given task comprises:
a mapping of an input image or any part thereof to classification scores with respect to one or more classes of a given classification, and/or
a segmentation of the input image into semantic sub-units.

The solving of these tasks in 2D is not too different from the solving in 3D. In particular, irrespective of whether the task is solved in 2D or in 3D, the end result is always of the same type, meaning that it is easier to evaluate the plausibility of the outcome of the auxiliary neural network with the outcome of the task neural network. Moreover, classification and segmentation tasks belong to the most frequently needed tasks in the context of the surveillance of the environment of a vehicle and/or robot.

In particular, the task neural network may be chosen to output bounding boxes of object instances as well as classification scores relating to these object instances. In one example, the bounding boxes may then be used to crop the depth map for the generation of the 3D representation. The plausibility between the outcomes of the task neural network and the auxiliary neural network may then measure some “circular consistency”: Some outcome of the task neural network is used to determine an input to the auxiliary neural network, and the outcome of the auxiliary neural network is them compared in some manner to the original outcome of the task neural network. In another example, the distribution of points in 3D space that the auxiliary neural network classifies into a particular class may be checked as to whether it corresponds to the bounding box determined by the task neural network.

In a further particular advantageous embodiment of the present invention, the outcome of the task neural network, and/or the outcome of the auxiliary neural network, that goes into the auxiliary loss function comprises outputs of intermediate layers before the respective final output layer. In particular, if the task of the auxiliary neural network is different from the given task, the outputs of respective intermediate layers may still be quite similar. As discussed above, the solving of both tasks may build on similar intermediate features. For example, a given classification task regarding types of object instances in an input image on the one hand and an auxiliary task of classifying a danger level of a traffic situation as a whole on the other hand may exploit same or similar features extracted from 2D training images, respectively from 3D representations.

In a further particularly advantageous embodiment of the present invention, the total loss comprises a weighted sum of the task loss and the auxiliary loss. In this manner, the relative weighting of the two loss contributions may be used as a hyperparameter to tune the strength of the regularization.

In a further particularly advantageous embodiment of the present invention, the auxiliary neural network is chosen to be trained on a domain that is a super-domain of the domain of the training images. In this manner, the better generalization of the task neural network may be steered towards this super-domain. Herein, the term “super-domain” means that members of the domain of the training images also belong to the super-domain, just like all elements in a set will also be elements of a super-set of this set. For example, if the training images comprise images of traffic signs as objects, the super-domain may comprise images with many possible types of object instances including traffic signs. An auxiliary network that has been trained on this super-domain will have seen far less training images from the domain of traffic signs than there are in the concrete set of training images at hand, but it will have seen at least some traffic signs, as well as at least some object instances of a lot of other domains. In particular, given a concrete application with a specific set of training images, an auxiliary network that has been generically trained on a super-domain is likely to be readily available.

As discussed above, the point of the training using 3D knowledge is to improve the generalization of the task neural network to domains of 2D images beyond the one to which the 2D training images belong. This generalization will improve the accuracy of the task neural network when processing input images beyond the domain of the training images.

Therefore, in a further particularly advantageous embodiment of the present invention, 2D input images that have been acquired with at least one sensor are provided. These input images are processed by the trained task neural network into task outputs. The task outputs will then benefit from said improved accuracy.

As discussed above, the acquisition of the 2D input images, the transmission of these input images from the sensor to the task neural network, and the processing of the input images by the task neural network can all happen in the 2D world with a much lower data volume than if all processing was done in 3D. But the final accuracy will nonetheless benefit from the 3D knowledge that has gone into the training.

In a further particularly advantageous embodiment of the present invention, the at least one sensor is carried by a vehicle and/or robot. Furthermore, in the course of the method, an actuation signal is computed. The vehicle and/or robot is actuated with the actuation signal. In this manner, the reaction that the vehicle and/or robot performs in response to the actuation signal is more likely to be appropriate in the given situation that is conveyed by the input images. Also, as discussed above, mobile applications in vehicles and/or robots benefit from the relatively small data volume of 2D images versus 3D images or point clouds. For example, a CAN bus that is commonly used in vehicles only has a maximum bandwidth of 1 Mbit/s.

The method may be wholly or partially computer-implemented and embodied in software. The present invention therefore also relates to a computer program with machine-readable instructions that, when executed by one or more computers and/or compute instances, cause the one or more computers and/or compute instances to perform the method according to the present invention described above. Herein, control units for vehicles or robots and other embedded systems that are able to execute machine-readable instructions are to be regarded as computers as well. Compute instances comprise virtual machines, containers or other execution environments that permit execution of machine-readable instructions in a cloud.

A non-transitory storage medium, and/or a download product, may comprise the computer program according to the present invention. A download product is an electronic product that may be sold online and transferred over a network for immediate fulfilment. One or more computers and/or compute instances may be equipped with said computer program, and/or with said non-transitory storage medium and/or download product.

In the following, the present invention will be described using Figures without any intention to limit the scope of the present invention.

### BRIEF DESCRIPTION OF THE DRAWINGS

FIG. 1 shows an exemplary embodiment of the method 100 for training a task neural network 1, according to the present invention.

FIG. 2 shows a visualization of the effect of the method 100 according to an example embodiment of the present invention.

### DETAILED DESCRIPTION OF EXAMPLE EMBODIMENTS

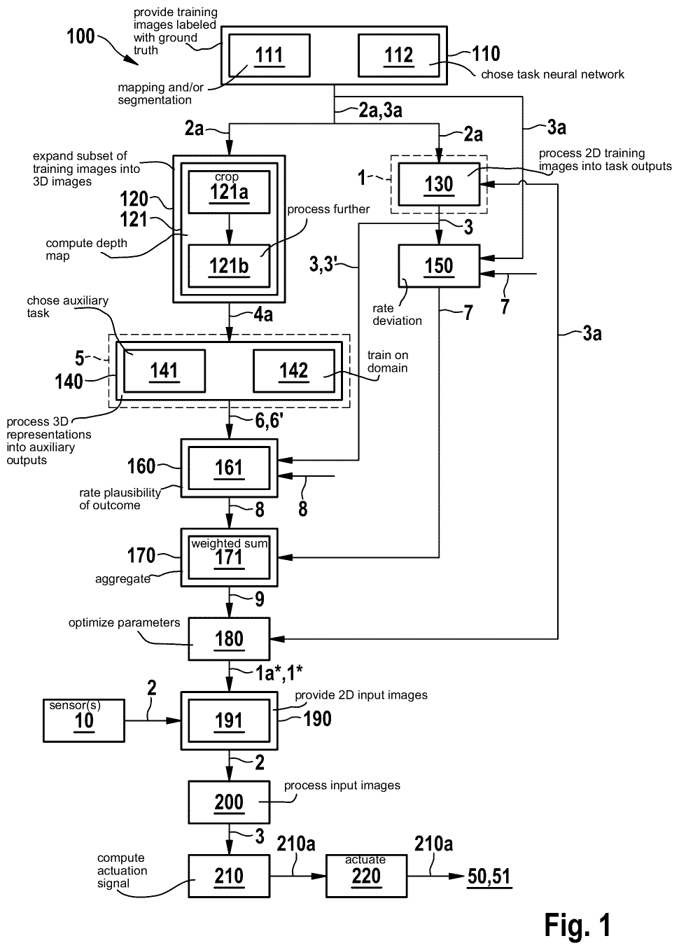

FIG. 1 is a schematic flow chart of an embodiment of the method 100 for training a task neural network 1. The training empowers the task neural network 1 for a given task that is to be performed on an input. This input comprises at least images 2.

In step 110, 2D training images 2a that are labelled with ground truth 3a with respect to the given task are provided.

According to block 111, the given task may comprise:
a mapping of an input image 2 or any part thereof to classification scores with respect to one or more classes of a given classification, and/or
a segmentation of the input image 2 into semantic sub-units.

According to block 112, the task neural network 1 may be chosen to output bounding boxes of object instances as well as classification scores relating to these object instances.

In step 120, at least a subset of the training images 2a is expanded into 3D representations 4a of the content of the respective training image 2a.

According to block 121, the expanding of at least one training image into a 3D representation may comprise computing a depth map that contains, for each pixel of the 2D training image 2a, a distance from the camera with which the training image 2a was recorded. According to block 121a, this depth map may be cropped 121a to comprise only a set of desired objects or other semantic sub-units of the training image 2a. It may, according to block 121b, be processed further into a 3D image that assigns pixel values of the 2D training image 2a to locations outside of the plane of this 2D training image 2a.

In step 130, the to-be-trained task neural network 1 processes the 2D training images 2a into task outputs 3.

In step 140, an auxiliary neural network 5 that is trained for an auxiliary task processes the 3D representations 4a into auxiliary outputs 6.

According to block 141, the auxiliary task may be chosen to correspond to the given task.

According to block 142, the auxiliary neural network 5 may be chosen to be trained on a domain that is a super-domain of the domain of the training images 2a.

In step 150, a task loss function 7 rates a deviation of the task output 3 for each training image 2a from the ground truth 3a with which this training image 2a is labelled.

In step 160, an auxiliary loss function 8 rates a plausibility of an outcome of the task neural network 1 produced from at least one training image 2a with the an outcome of the auxiliary neural network 5 produced from the corresponding 3D representation 4a. In particular, the outcome of the task neural network 1 may be the task output 3 produced from the training image 2a, and/or an intermediate work product 3′ that is generated while calculating the task output 3. Likewise, the outcome of the auxiliary neural network 5 may be the auxiliary output 6 produced from the 3D representation 4a, and/or an intermediate work product 6′ that is generated while calculating the auxiliary output 6.

Thus, according to block 161, the outcome of the task neural network 1, and/or the outcome of the auxiliary neural network 5, that goes into the auxiliary loss function may comprise outputs 3′, 6′ of intermediate layers before the respective final output layer.

In step 170, the value of the task loss function 7 and the value of the auxiliary loss function 8 are aggregated to form a total loss 9.

According to block 171, the total loss 9 may comprise a weighted sum of the task loss 7 and the auxiliary loss 8.

In step 180, parameters 1a that characterize the behavior of the task neural network 1 are optimized towards the goal of improving the total loss 9. These parameters 1a are fed back to the processing of the training images 2a by the task neural network 1 in step 130. The finally optimized state of the parameters is labelled with the reference sign 1a*. This set of parameters also defines the finally trained state 1* of the task neural network 1.

In step 190, 2D input images 2 that have been acquired with at least one sensor 10 are provided.

According to block 191, the at least one sensor 10 may be carried by a vehicle 50 and/or robot 51.

In step 200, the trained task neural network 1 processes the input images 2 into task outputs 3.

In step 210, an actuation signal 210a is computed from the task outputs 3.

In step 220, the vehicle 50 and/or robot 51 is actuated with the actuation signal 210a.

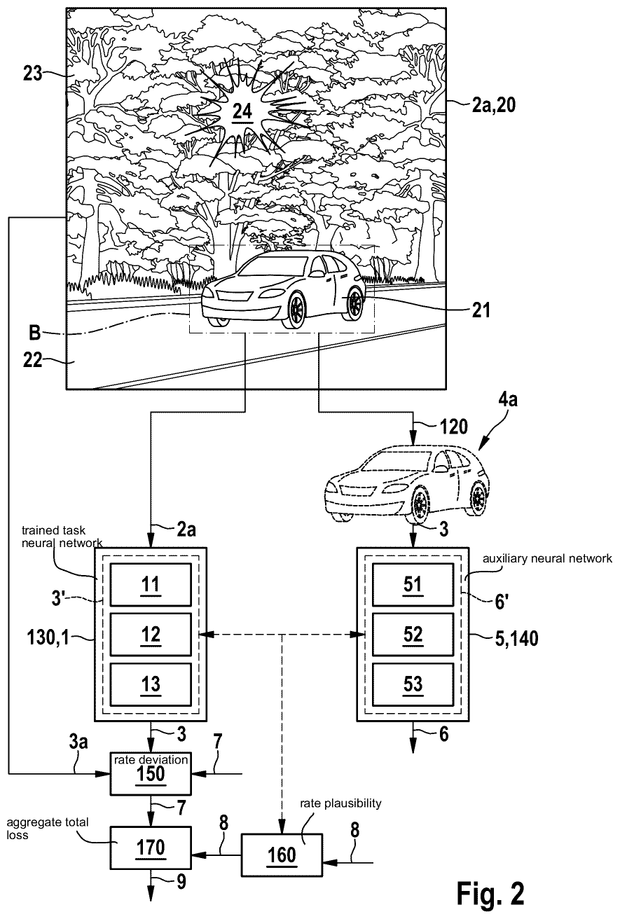

FIG. 2 illustrates on an example how the use of an auxiliary network 5 can aid the training of a to-be-trained task neural network 1.

In the example shown in FIG. 2, the training image 2a shows a traffic scene 20 with a car 21 on a road 22. In the background, a tree line 23 is visible, and the sun 24 is shining through the tree line 23. The car 21 has already been identified as an object instance of unknown type and marked with a bounding box B.

The content of the bounding box B is provided to the to-be-trained task neural network 1, as per step 130 of the method 100. The trained task neural network 1 produces a task output 3 from the content of the bounding box B. During this computation, the three layers 11-13 of the task neural network 1 produce intermediate work products 3′.

The training image 2a is labelled with ground truth 3a with respect to the given task, here: a classification of object instances. In step 150 of the method 100, a task loss function 7 rates a deviation of the task output 3 from the ground truth 3a.

The content of the bounding box B is also expanded into a 3D representation 4a, here: a point cloud. This 3D representation 4a is provided to the auxiliary neural network 5 and processes into an auxiliary output 6. During this computation, the three layers 51-53 of the auxiliary neural network 5 produce intermediate work products 6′.

In step 160 of the method 100, an auxiliary loss function 8 rates a plausibility of the intermediate work products 3′ from the task neural network 1 with the intermediate work products 6′ from the auxiliary neural network 5.

In step 170 of the method 100, a total loss 9 is aggregated from the value of the task loss function 7 and the value of the auxiliary loss function 8.

As discussed above, in this manner, the task neural network 1 is trained to base its decisions more on easily generalizable features, such as geometry features, than on lighting conditions, textures or other properties that may be less suitable to distinguish object instances under certain conditions. If the task neural network 1 bases its decisions on those other properties, it may achieve a better task loss 7, but the intermediate work products 3′ will become very different from the intermediate work products 6′ produced from the 3D representation 4a. This will be penalized by the auxiliary loss 8.

What is claimed is:

1. A method for training a task neural network for a given task that is to be performed on an input including at least images, the method comprising the following steps:
providing 2D training images that are labelled with ground truth with respect to the given task;
expanding each respective training image of at least a subset of the training images into 3D representations of content of the respective training image;
processing, by the to-be-trained task neural network, the 2D training images into task outputs;
processing, by an auxiliary neural network that is trained for an auxiliary task, the 3D representations into auxiliary outputs;
rating, by a task loss function, a deviation of the task output for each training image from the ground truth with which the training image is labelled;
rating, by an auxiliary loss function, a plausibility of an outcome of the task neural network produced from at least one training image with the an outcome of the auxiliary neural network produced from a corresponding 3D representation;
aggregating a value of the task loss function and a value of the auxiliary loss function into a total loss; and
optimizing parameters that characterize a behavior of the task neural network towards a goal of improving the total loss.

2. The method of claim 1, wherein the auxiliary task is chosen to correspond to the given task.

3. The method of claim 1, wherein the expanding of each respective training image into the 3D representation includes computing a depth map that contains, for each pixel of the training image, a distance from a camera with which the training image was recorded.

4. The method of claim 3, wherein the depth map is processed further into a 3D image that assigns pixel values of the training image to locations outside of a plane of the training image.

5. The method of claim 4, wherein, before the processing into the 3D image, the depth map is cropped to include only a set of desired objects or other semantic sub-units of the training image.

6. The method of claim 1, wherein the given task includes:
a mapping of an input image or any part of the input image to classification scores with respect to one or more classes of a given classification, and/or
a segmentation of the input image into semantic sub-units.

7. The method of claim 6, wherein the task neural network is chosen to output bounding boxes of object instances and classification scores relating to the object instances.

8. The method of claim 1, wherein the outcome of the task neural network, and/or the outcome of the auxiliary neural network, that goes into the auxiliary loss function includes outputs of intermediate layers before a respective final output layer of the task neural network and/or auxiliary neural network.

9. The method of claim 1, wherein the total loss includes a weighted sum of a task loss and an auxiliary loss.

10. The method of claim 1, wherein the auxiliary neural network is chosen to be trained on a domain that is a super-domain of a domain of the training images.

11. The method of claim 1, further comprising:
providing 2D input images that have been acquired with at least one sensor; and
processing, by the trained task neural network, the input images into task outputs.

12. The method of claim 11, wherein the at least one sensor is carried by a vehicle and/or robot, and the method further comprises:
computing, from the task outputs, an actuation signal; and
actuating, with the actuation signal, the vehicle and/or robot.

13. A non-transitory machine-readable data carrier on which is stored a computer program including machine-readable instructions for training a task neural network for a given task that is to be performed on an input including at least images, the instructions, when executed by one or more computers and/or compute instances, causing the one or more computers and/or compute instances to perform the following steps:
providing 2D training images that are labelled with ground truth with respect to the given task;
expanding each respective training image of at least a subset of the training images into 3D representations of content of the respective training image;
processing, by the to-be-trained task neural network, the 2D training images into task outputs;
processing, by an auxiliary neural network that is trained for an auxiliary task, the 3D representations into auxiliary outputs;
rating, by a task loss function, a deviation of the task output for each training image from the ground truth with which the training image is labelled;
rating, by an auxiliary loss function, a plausibility of an outcome of the task neural network produced from at least one training image with the an outcome of the auxiliary neural network produced from a corresponding 3D representation;
aggregating a value of the task loss function and a value of the auxiliary loss function into a total loss; and
optimizing parameters that characterize a behavior of the task neural network towards a goal of improving the total loss.

14. One or more computers and/or compute instances including a non-transitory machine-readable data carrier on which is stored a computer program including machine-readable instructions for training a task neural network for a given task that is to be performed on an input including at least images, the instructions, when executed by the one or more computers and/or compute instances, causing the one or more computers and/or compute instances to perform the following steps:
providing 2D training images that are labelled with ground truth with respect to the given task;
expanding each respective training image of at least a subset of the training images into 3D representations of content of the respective training image;
processing, by the to-be-trained task neural network, the 2D training images into task outputs;
processing, by an auxiliary neural network that is trained for an auxiliary task, the 3D representations into auxiliary outputs;
rating, by a task loss function, a deviation of the task output for each training image from the ground truth with which the training image is labelled;
rating, by an auxiliary loss function, a plausibility of an outcome of the task neural network produced from at least one training image with the an outcome of the auxiliary neural network produced from a corresponding 3D representation;
aggregating a value of the task loss function and a value of the auxiliary loss function into a total loss; and
optimizing parameters that characterize a behavior of the task neural network towards a goal of improving the total loss.
